(19) United States
(12) Patent Application Publication
(10) Pub. No.: US 2016/0285775 A1
(43) Pub. Date: Sep. 29, 2016

(54) WIRELESS RESOURCE ALLOCATION AND BUFFER STATUS REPORTING BASED ON PACKET SIZE

(71) Applicant: QUALCOMM Incorporated, San Diego, CA (US)

(72) Inventors: Jelena Damnjanovic, Del Mar, CA (US); Madhavan Srinivasan Vajapeyam, San Diego, CA (US); Jun Wang, Poway, CA (US); Aleksandar Damnjanovic, Del Mar, CA (US)

(21) Appl. No.: 15/066,935

(22) Filed: Mar. 10, 2016

Related U.S. Application Data
(60) Provisional application No. 62/137,469, filed on Mar. 24, 2015.

(51) Int. Cl. H04L 12/835; H04W 72/04; H04B 14/02

(52) U.S. Cl. CPC H04L 47/30; H04B 14/026; H04W 72/0453

(57) ABSTRACT

Wireless resource allocation and buffer status reporting may be based on packet size, and a base station may allocate resources for communications with a user equipment (UE) to provide resources for an integer number of packets. For downlink communications from a base station to a UE, a scheduler may allocate resources to transmit an integer number of packets, based on packet size and a number of packets to be transmitted. For uplink communications, a UE may transmit a buffer status report (BSR) that indicates packet size and a number of packets to be transmitted. A base station may allocate uplink resources to the UE that correspond to an integer number of packets. Resources may be allocated that have a variable length transmission time interval (TTI) that may be adjusted, alone or in combination with other resources (e.g., frequency resources), to provide for transmission of an integer number of packets.

### CROSS REFERENCES

The present application for patent claims priority to U.S. Provisional Patent Application No. 62/137,469 by Damnjanovic et al., entitled “Wireless Resource Allocation and Buffer Reporting Based On Packet Size,” filed Mar. 24, 2015, assigned to the assignee hereof, and expressly incorporated by reference herein.

### BACKGROUND

The following relates generally to wireless communication, and more specifically to resource allocation and buffer status reporting in wireless communications networks. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

In some wireless communication systems, a wireless communication device may communicate with a base station using carriers associated with different timing configurations. For instance, transmissions may have variable length transmission time intervals (TTIs). In some traditional wireless network deployments, a radio link control (RLC) layer may provide segmentation and reassembly of higher layer data packets, retransmission of lost data packets, and reordering of data packets to compensate for out-of-order reception (e.g., due to hybrid automatic repeat request (HARQ)). Operations of the RLC layer may add to processing times and overhead related to wireless communications. Thus, it may be advantageous to reduce or eliminate the need for RLC processing for data transmitted and received in a wireless communications system.

### SUMMARY

Systems, methods, and apparatuses for wireless resource allocation and buffer status reporting based on packet size are described. In some examples, a base station may allocate resources for communications with a user equipment (UE) such that segmentation of packets may not be necessary, thereby reducing or eliminating the need for radio link control (RLC) layer processing. For downlink communications from the base station to a UE, a scheduler may allocate resources based on packet data convergence layer (PDCP) packet size and a number of packets to provide downlink resources sufficient to transmit an integer number of PDCP packets. For uplink communications, a UE may transmit a buffer status report (BSR) that indicates a number of different parts of data that is to be transmitted, such as a number of PDCP packets and an associated packet size of uplink data in the UE buffer. A base station may receive the BSR and allocate uplink resources to the UE with reduced or no segmentation of parts of uplink data. In some examples, a base station may receive a segmented BSR that indicates a number of PDCP packets and packet size for portions of buffered uplink data, and a scheduler at the base station may allocate uplink resources sufficient to allow the UE to transmit an integer number of PDCP packets. Resources may be allocated that have a variable length transmission time interval (TTI) that may be adjusted, alone or in combination with other resources (e.g., frequency resources), to provide sufficient resources for transmission of an integer number of PDCP packets.

A method of wireless communication at a wireless device is described. The method may include identifying data that is to be transmitted to a receiver, determining a PDCP packet size and a number of PDCP packets to be used to transmit the data, and scheduling, based at least in part on the PDCP packet size and the number of PDCP packets, wireless resources for use in transmitting the data.

An apparatus for wireless communication at a wireless device is described. The apparatus may include means for identifying data that is to be transmitted to a receiver, means for determining a PDCP packet size and a number of PDCP packets to be used to transmit the data, and means for scheduling, based at least in part on the PDCP packet size and the number of PDCP packets, wireless resources for use in transmitting the data.

A further apparatus for wireless communication at a wireless device is described. The apparatus may include a processor, memory in electronic communication with the processor, and instructions stored in the memory, wherein the instructions are executable by the processor to identify data that is to be transmitted to a receiver, determine a PDCP packet size and a number of PDCP packets to be used to transmit the data, and schedule, based at least in part on the PDCP packet size and the number of PDCP packets, wireless resources for use in transmitting the data.

A non-transitory computer-readable medium storing code for wireless communication at a wireless device is described. The code may include instructions executable to identify data that is to be transmitted to a receiver, determine a PDCP packet size and a number of PDCP packets to be used to transmit the data, and schedule, based at least in part on the PDCP packet size and the number of PDCP packets, wireless resources for use in transmitting the data.

In some examples of the method, apparatuses, or non-transitory computer-readable medium described above, the scheduling comprises scheduling the wireless resources to provide an integer number of PDCP packets. Additionally or alternatively, in some examples the scheduling further comprises adapting a TTI of one or more available wireless resources to provide the integer number of PDCP packets.

In some examples of the method, apparatuses, or non-transitory computer-readable medium described above, the scheduling further comprises determining one or more frequency resources for transmitting the data, and the adapting the TTI comprises determining the TTI based on one or more of the frequency resources, the PDCP packet size, or the number of PDCP packets to provide the integer number of PDCP packets. Additionally or alternatively, in some examples the identifying and the determining are performed at a PDCP layer, and wherein the method further comprises providing the data, PDCP packet size, and number of PDCP packets to a medium access control (MAC) layer for transmission to the receiver.

In some examples of the method, apparatuses, or non-transitory computer-readable medium described above, the scheduling is performed by a scheduler that is associated with the MAC layer.

A method of wireless communication at a wireless device is described. The method may include identifying data that is to be transmitted to a receiver, segmenting the identified data into a plurality of parts, and generating a BSR that identifies the segmented parts and sizes for the segmented parts.

An apparatus for wireless communication at a wireless device is described. The apparatus may include means for identifying data that is to be transmitted to a receiver, means for segmenting the identified data into a plurality of parts, and means for generating a BSR that identifies the segmented parts and sizes for the segmented parts.

A further apparatus for wireless communication at a wireless device is described. The apparatus may include a processor, memory in electronic communication with the processor, and instructions stored in the memory, wherein the instructions are executable by the processor to identify data that is to be transmitted to a receiver, segment the identified data into a plurality of parts, and generate a BSR that identifies the segmented parts and sizes for the segmented parts.

A non-transitory computer-readable medium storing code for wireless communication at a wireless device is described. The code may include instructions executable to identify data that is to be transmitted to a receiver, segment the identified data into a plurality of parts, and generate a BSR that identifies the segmented parts and sizes for the segmented parts.

Some examples of the method, apparatus, or non-transitory computer-readable medium described above may further include processes, features, means, or instructions for transmitting the BSR to a base station, and receiving an allocation of resources from the base station for transmitting the data, the allocation of resources providing wireless resources corresponding to an integer number of PDCP packets based at least in part on the sizes for the segmented parts and the integer number of PDCP packets.

In some examples of the method, apparatuses, or non-transitory computer-readable medium described above, the allocation of resources provides wireless resources for transmitting a subset of the integer number of PDCP packets. Additionally or alternatively, in some examples the allocation of resources comprises an indication of frequency resources for transmitting the data and a TTI to be used for transmitting the data.

In some examples of the method, apparatuses, or non-transitory computer-readable medium described above, the BSR comprises a plurality of segments corresponding to a number of PDCP packets and an indication of a number of bits for a segment of the plurality of segments corresponding to a PDCP packet size. In some examples of the method, apparatuses, or non-transitory computer-readable medium described above, the BSR comprises a plurality of segments, a segment of the plurality of segments corresponding to a part size bin and the segment indicating a number of parts within the part size bin. Additionally or alternatively, in some examples the segment and the part size bin for the segment is determined based at least in part on one or more of a predetermined BSR configuration, or a semi-statically configured BSR configuration.

In some examples of the method, apparatuses, or non-transitory computer-readable medium described above, the BSR further comprises an indication of a location in a transmission queue where a majority of parts of the part size bin fall. Additionally or alternatively, in some examples the BSR comprises a plurality of segments, a segment of the plurality of segments having one or more of a minimum or maximum value to indicate a part size associated with the segment.

In some examples of the method, apparatuses, or non-transitory computer-readable medium described above, the plurality of parts corresponds to an integer number of PDCP packets, and a number of PDCP packets reported in the segment is selected to prioritize one or more PDCP packets. Additionally or alternatively, in some examples the plurality of parts corresponds to an integer number of PDCP packets, and a number of PDCP packets reported in the segment is selected to balance PDCP packets reported in the segment.

In some examples of the method, apparatuses, or non-transitory computer-readable medium described above, the BSR comprises one or more BSR segments, a number of BSR segments determined based at least in part on a number of the plurality of parts. Additionally or alternatively, in some examples the BSR further comprises an indication of the number of BSR segments. In some examples of the method, apparatuses, or non-transitory computer-readable medium described above, the identified data is associated with a first portion of data in a buffer, and wherein the BSR further identifies a size for a non-segmented portion of data in the buffer.

In some examples of the method, apparatuses, or non-transitory computer-readable medium described above, the BSR further comprises an indication that additional data is to be transmitted. Some examples of the method, apparatus, or non-transitory computer-readable medium described above may further include processes, features, means, or instructions for determining that the additional data is to be transmitted, the additional data having higher priority than a first logical channel prioritization, wherein the BSR is based at least in part on data having the first logical channel prioritization, and determining to transmit the additional data ahead of the data having the first logical channel prioritization based at least in part on an allocation of wireless resources received responsive to the BSR.

A method of wireless communication at a wireless device is described. The method may include receiving a buffer status report from a UE that identifies a plurality of segmented parts and sizes for the segmented parts, and allocating wireless resources to the UE based at least in part on a number of the segmented parts and the sizes for the segmented parts.

An apparatus for wireless communication at a wireless device is described. The apparatus may include means for receiving a buffer status report from a UE that identifies a plurality of segmented parts and sizes for the segmented parts, and allocating wireless resources to the UE based at least in part on a number of the segmented parts and the sizes for the segmented parts.

A further apparatus for wireless communication at a wireless device is described. The apparatus may include a processor, memory in electronic communication with the processor, and instructions stored in the memory, wherein the instructions are executable by the processor to receive a buffer status report from a UE that identifies a plurality of segmented parts and sizes for the segmented parts, and allocate wireless resources to the UE based at least in part on a number of the segmented parts and the sizes for the segmented parts.

A non-transitory computer-readable medium storing code for wireless communication at a wireless device is described. The code may include instructions executable to receive a buffer status report from a UE that identifies a plurality of segmented parts and sizes for the segmented parts, and allocate wireless resources to the UE based at least in part on a number of the segmented parts and the sizes for the segmented parts.

In some examples of the method, apparatuses, or non-transitory computer-readable medium described above, the plurality of segmented parts corresponds to an integer number of PDCP packets. Some examples of the method, apparatus, or non-transitory computer-readable medium described above may further include processes, features, means, or instructions for adapting a TTI of one or more available wireless resources to provide the integer number of PDCP packets.

Some examples of the method, apparatus, or non-transitory computer-readable medium described above may further include processes, features, means, or instructions for identifying data that is to be transmitted to a UE, determining a PDCP packet size and a number of PDCP packets to be used to transmit the data, and scheduling, based at least in part on the PDCP packet size and the number of PDCP packets, wireless resources for use in transmitting the data.

In some examples of the method, apparatuses, or non-transitory computer-readable medium described above, the identifying and the determining are performed at a PDCP layer. Some examples of the method, apparatus, or non-transitory computer-readable medium described above may further include processes, features, means, or instructions for providing the data, the PDCP packet size, and the number of PDCP packets to a MAC layer for transmission to the UE. In some examples of the method, apparatuses, or non-transitory computer-readable medium described above, the scheduling is performed by a scheduler that is associated with the MAC layer.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

The disclosure may be understood by reference to the following drawings:

FIG. 1 illustrates an example of a wireless communications system that supports wireless resource allocation and buffer status reporting based on packet size in accordance with various aspects of the present disclosure;

FIG. 2 illustrates an example of a wireless communications system that supports wireless resource allocation and buffer status reporting based on packet size in accordance with various aspects of the present disclosure;

FIG. 3 is a diagram illustrating an example of a radio protocol architecture for user and control planes in accordance with various aspects of the present disclosure;

FIG. 4 illustrates an example of a wireless communications TTI that corresponds to an integer number of PDCP packets in accordance with various aspects of the present disclosure;

FIGS. 5A and 5B illustrate examples of segmented BSRs in accordance with various aspects of the present disclosure;

FIG. 6 illustrates an example of a process flow in systems that support wireless resource allocation and buffer status reporting based on packet size in accordance with various aspects of the present disclosure;

FIG. 7 shows a diagram of a UE configured for buffer status reporting based on packet size in accordance with various aspects of the present disclosure;

FIG. 8 shows a diagram of a UE configured for buffer status reporting based on packet size in accordance with various aspects of the present disclosure;

FIG. 9 shows a diagram of a BSR module configured for buffer status reporting based on packet size in accordance with various aspects of the present disclosure;

FIG. 10 illustrates a diagram of a system including a UE configured for buffer status reporting based on packet size in accordance with various aspects of the present disclosure;

FIG. 11 shows a diagram of a base station configured for wireless resource allocation based on packet size in accordance with various aspects of the present disclosure;

FIG. 12 shows a diagram of a base station configured for wireless resource allocation based on packet size in accordance with various aspects of the present disclosure;

FIG. 13 shows a diagram of a base station resource allocation module configured for wireless resource allocation based on packet size in accordance with various aspects of the present disclosure;

FIG. 14 illustrates a diagram of a system including a base station configured for wireless resource allocation based on packet size in accordance with various aspects of the present disclosure;

FIG. 15 shows a flowchart illustrating a method for wireless resource allocation based on packet size in accordance with various aspects of the present disclosure;

FIG. 16 shows a flowchart illustrating a method for buffer status reporting based on packet size in accordance with various aspects of the present disclosure;

FIG. 17 shows a flowchart illustrating a method for buffer status reporting based on packet size in accordance with various aspects of the present disclosure; and

FIG. 18 shows a flowchart illustrating a method for wireless resource allocation based on packet size in accordance with various aspects of the present disclosure.

### DETAILED DESCRIPTION

According to the present disclosure, radio link control (RLC) layer processing may be reduced or eliminated through reduced or eliminated need for segmentation at the RLC layer. Variable resource allocations may be provided for wireless communications, according to various examples, that may provide for transmission of integer numbers of data packets and thus reduce or eliminate the need for segmentation, and associated reassembly, at the RLC layer. In some examples, a base station may allocate uplink and downlink resources for communications with a user equipment (UE) such that segmentation of packets may not be necessary.

For downlink communications from the base station to a UE, a scheduler may allocate resources based on packet data convergence layer (PDCP) packet size and a number of packets to provide downlink resources that correspond to an integer number of PDCP packets. For uplink communications, a UE may transmit a buffer status report (BSR) that indicates a number of different parts of data that is to be transmitted, such as a number of PDCP packets and an associated packet size of uplink data in a buffer of the UE. A base station may receive the BSR and allocate uplink resources to the UE with reduced or no segmentation of parts of the uplink data.

In some examples, a base station may receive a BSR that indicates a number of segmented parts (e.g. an integer number of PDCP packets) and sizes for the segmented parts (e.g. sizes of the PDCP packets) for portions of buffered uplink data, and a scheduler at the base station may allocate uplink resources to a UE that correspond to an integer number of PDCP packets. Resources may be allocated that have a variable length transmission time interval (TTI) that may be adjusted, alone or in combination with other resources (e.g., frequency resources), to provide resources for transmission of an integer number of PDCP packets.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

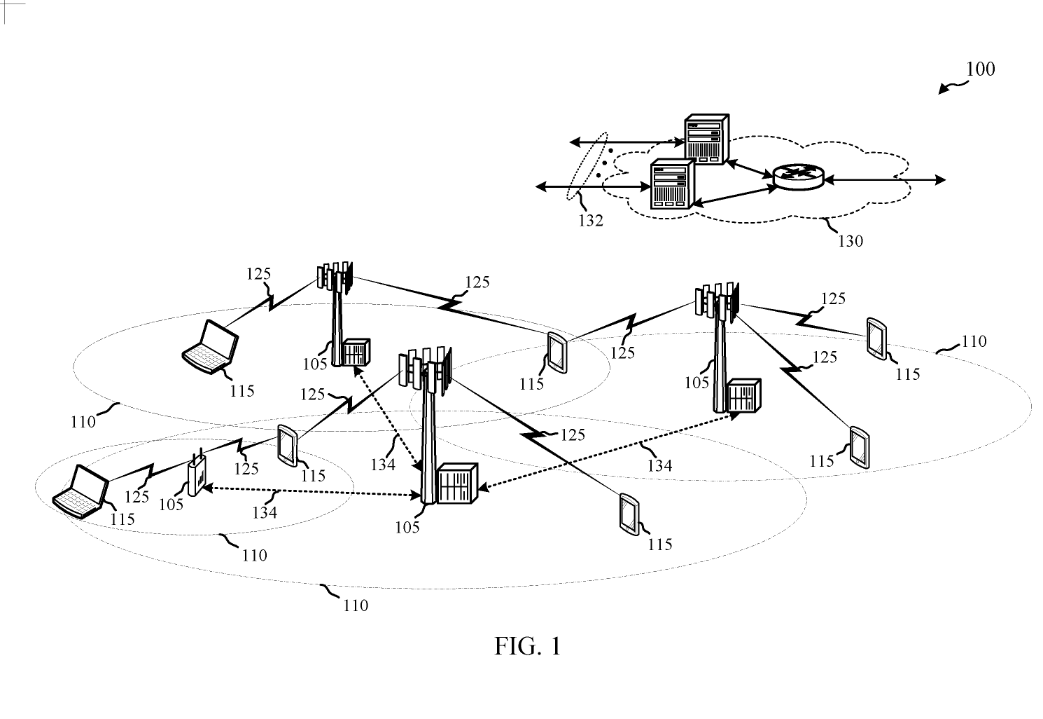

FIG. 1 illustrates an example of a wireless communications system 100 that supports wireless resource allocation and buffer status reporting based on packet size in accordance with various aspects of the present disclosure. The wireless communications system 100 includes base stations 105, UEs 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X2, etc.), which may be wired or wireless communication links.

The base stations 105 may wirelessly communicate with the UEs 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro or small cell base stations). There may be overlapping geographic coverage areas 110 for different technologies.

In some examples, the wireless communications system 100 is a Long Term Evolution (LTE)/LTE-Advanced (LTE-A) network. In LTE/LTE-A networks, the term evolved node B (eNB) may be generally used to describe the base stations 105. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack and data in the user plane may be based on IP. As mentioned above, a RLC layer may perform packet segmentation and reassembly to communicate over logical channels. A medium access control (MAC) layer may perform priority handling and multiplexing of logical channels into transport channels. The transport channels may be in transport blocks at the bottom of the MAC. The MAC layer may also use hybrid automatic repeat request (HARM) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels. For example, a MAC layer transport block may be mapped to a subframe at the PHY layer. The transport block may include a (cyclic redundancy check) CRC field for error detection at the receiver. As mentioned above, in some examples RLC layer processing may be reduced or eliminated through techniques described herein.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

In some examples of the wireless communications system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, or the like. The terms “carrier,” “component carrier,” and “cell” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced CCs (eCC). An eCC may be characterized by features including flexible bandwidth, variable length TTIs, and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is licensed to use the spectrum). An eCC characterized by flexible bandwidth may include one or more segments that may be utilized by UEs 115 that are not capable of monitoring the whole bandwidth or prefer to use a limited bandwidth (e.g., to conserve power).

In some cases, eCC deployments may utilize one or both of a variable transmission length (e.g., variable length TTI) and a variable symbol duration. In some cases an eCC may include multiple hierarchical layers associated with the different transmission lengths. For example, transmission lengths at one hierarchical layer may correspond to uniform 1 ms subframes, whereas in a second layer, variable transmission lengths may correspond to bursts of short duration symbol periods. In some cases, a shorter symbol duration may also be associated with increased subcarrier spacing. In other examples, the numerology of resources of an eCC may be different from numerology of another CC, which may employ transmission lengths defined in a version or release of, for example, a particular LTE standard. As mentioned above, in some aspects of the present disclosure time and/or frequency resources may be selected to provide communications between a UE 115 and a base station 105 that include integer numbers of packets, thus reducing segmentation that may be required at, for example, a RLC layer. Such techniques may be used for one CC, such as an eCC associated with a secondary cell (SCell), while different techniques may be used for another CC associated with a primary cell (PCell).

Wireless communication system 100 may implement error detection codes for transmissions to detect accidental changes to raw data. For example, a CRC may be used to detect errors during the decoding of received data. Before transmission, the CRC may be derived from the data according to a predetermined calculation. The CRC may then be appended to the data, which is subsequently transmitted. The receiving entity may perform the same calculation and check the result against the CRC bits. If the CRC bits do not match the calculated value, the CRC may be deemed to have failed, and the receiving entity may determine that the data has been corrupted.

HARQ may be a method of ensuring that data is received correctly over a communication link 125. The MAC layer may be responsible for managing the HARQ function, which may be a transport block level automatic retry. HARQ may include a combination of error detection (e.g., using a CRC), forward error correction (FEC), and retransmission (e.g., automatic repeat request (ARQ)). HARQ may improve throughput at the MAC layer in poor radio conditions (e.g., signal-to-noise conditions). In Incremental Redundancy HARQ, incorrectly received data may be stored in a buffer and combined with subsequent transmissions to improve the overall likelihood of successfully decoding the data.

A base station 105 may schedule DL resources using a physical downlink control channel (PDCCH). PDCCH may carry downlink control information (DCI) in control channel elements (CCEs), which may include a number of logically contiguous resource element groups (REGs), where each REG contains a number of resource elements (REs). DCI may include information regarding DL scheduling assignments, UL resource grants, transmission scheme, UL power control, HARQ information, modulation and coding scheme (MCS) and other information. The size and format of the DCI messages can differ depending on the type and amount of information that is carried by the DCI. For example, if spatial multiplexing is supported, the size of the DCI message is large compared to contiguous frequency allocations. Similarly, for a system that employs MIMO, the DCI may include additional signaling information. DCI size and format depend on the amount of information as well as factors such as bandwidth, the number of antenna ports, and duplexing mode. According to some aspects of the present disclosure, the DCI may include DL scheduling assignments or UL resource grants that identify allocated resources and resource characteristics (e.g., variable TTI information) that allow for transmission of integer numbers of packets within a particular allocation of resources.

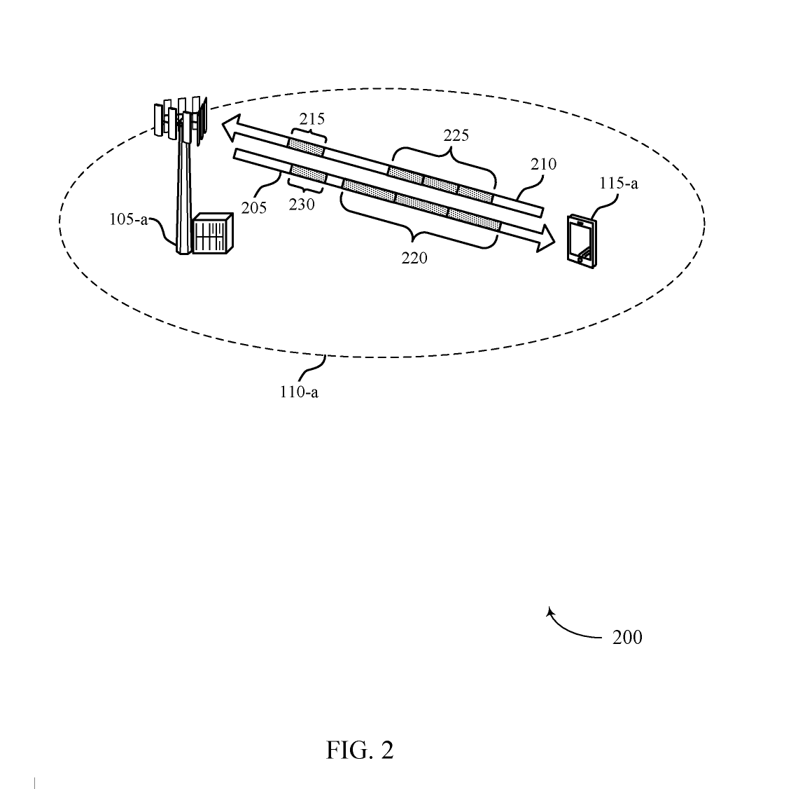

FIG. 2 illustrates an example of a wireless communications system 200 that supports wireless resource allocation and buffer status reporting based on packet size in accordance with various aspects of the present disclosure. Wireless communications system 200 may include UE 115-a and a base station 105-a which may be examples of devices described herein, and with reference to FIG. 1. Base station 105-a may communicate (e.g., using CA) with any UE 115 within geographic coverage area 110-a. For example, base station 105-a may exchange data and control information with UE 115-a via downlink transmissions 205 and uplink transmissions 210. In some examples, downlink transmissions 205 and uplink transmissions 210 may be transmitted using one or more CCs, such as PCell and eCC SCell CCs.

In some cases, downlink transmissions 205 and uplink transmissions 210 may include TTIs that are shorter in duration (e.g., shorter than a subframe), and also may include variable length TTIs. For example, a variable length TTI may be an integer number of symbol periods. UE 115-a may receive information from base station 105-a in downlink transmissions 205, which may include data transmitted in downlink resources 220 and control information 230 (e.g., DCI) that may include an uplink grant to the UE 115-a for subsequent transmissions of uplink data. In some examples, downlink resources may correspond to an integer number of packets transmitted from the base station 105-a to the UE 115-a. The UE 115-a may send information to base station 105-a in uplink transmissions 210, which may include a buffer status report 215 and uplink data transmitted in uplink resources 225. In some examples, uplink resources may correspond to an integer number of packets transmitted from the UE 115-a to the base station 105-a.

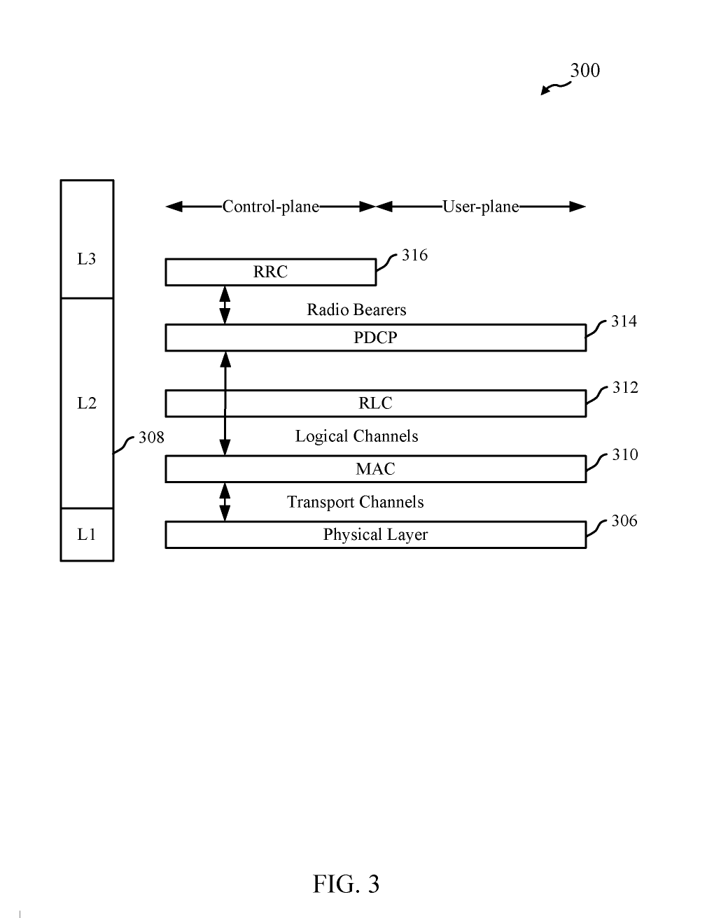

FIG. 3 shows a diagram illustrating an example of a radio protocol architecture 300 for user and control planes. Radio protocol architecture 300 may be used for wireless communications in wireless communications systems, such as wireless communications systems 100 and 200 described with reference to FIG. 1 and FIG. 2. The radio protocol architecture 300 for UEs (e.g., UEs 115 of FIG. 1 and FIG. 2) and base stations (e.g., base stations 105 of FIG. 1 and FIG. 2) is shown with three layers: Layer 1, Layer 2, and Layer 3. Layer 1 (L1 layer) is the lowest layer and implements various physical layer signal processing functions. The L1 layer will be referred to as physical layer 306. Layer 2 (L2 layer) 308 is above the physical layer 306 and is responsible for the link between the UE and base station over the physical layer 306.

In the user plane, the L2 layer 308 includes a MAC sublayer 310, a RLC sublayer 312, and a PDCP sublayer 314, which are terminated at the base station on the network side. Although not shown, the UE may have several upper layers above the L2 layer 308 including a network layer (e.g., IP layer) that may be terminated at, for example, a packet data network (PDN) gateway, and an application layer that may be terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between base stations. As mentioned above, the RLC sublayer 312 provides segmentation and reassembly of upper layer data packets, retransmission of lost data packets, and reordering of data packets to compensate for out-of-order reception due to HARQ. The RLC sublayer 312 passes data to the MAC sublayer 310 as logical channels.

In some examples, certain packets or logical channels may pass directly between the PDCP sublayer 314 and the MAC sublayer 310. For example, certain deployments may implement retransmission and reordering of packets at the PDCP sublayer 314, in which case the RLC sublayer 312 processing for such activities may not be necessary. Furthermore, according to various techniques described herein, data may be transmitted between UEs and base stations such that integer numbers of data packets (e.g., integer numbers of PDCP packets) are transmitted using allocated wireless resources. In such cases, segmentation and reassembly of data packets may not be required at the RLC sublayer 312, and for such data RLC processing at the RLC sublayer 312 may be omitted entirely. Such reduced processing may provide benefits of avoiding RLC buffering used for RLC reordering as well as reduced implementation processing and overhead, which may provide more efficient processing and reduced delay for received data being provided to higher layers.

The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations. The MAC sublayer formats and sends the logical channel data to the physical layer 306 as transport channels.

The DL transport channels may include a broadcast channel (BCH), a DL shared data channel (DL-SCH), a multicast channel (MCH) and a Paging Channel (PCH). The UL transport channels may include a random access channel (RACH), a request channel (REQCH), an uplink shared data channel (UL-SDCH) and a plurality of physical channels. The physical channels may also include a set of downlink and uplink channels. In some disclosed embodiments, the downlink physical channels may include at least one of a common pilot channel (CPICH), a synchronization channel (SCH), a common control channel (CCCH), a shared downlink control channel (SDCCH), a multicast control channel (MCCH), a shared uplink assignment channel (SUACH), an acknowledgement channel (ACKCH), a downlink physical shared data channel (DL-PSDCH), an uplink power control channel (UPCCH), a paging indicator channel (PICH), a load indicator channel (LICH), a physical broadcast channel (PBCH), a physical control format indicator channel (PCFICH), a PDCCH, a physical hybrid ARQ indicator channel (PHICH), a physical downlink shared channel (PDSCH) and a physical multicast channel (PMCH). The uplink physical channels may include at least one of a physical random access channel (PRACH), a channel quality indicator channel (CQICH), an acknowledgement channel (ACKCH), an antenna subset indicator channel (ASICH), a shared request channel (SREQCH), an uplink physical shared data channel (UL-PSDCH), a broadband pilot channel (BPICH), a physical uplink control channel (PUCCH) and a physical uplink shared channel (PUSCH).

In the control plane, the radio protocol architecture for the UE and base station may be the same for the physical layer 306 and the L2 layer 308 with the exception that there is no header compression function for the control plane. The control plane also includes a RRC sublayer 316 in Layer 3 (L3 layer). The RRC sublayer 316 is responsible for obtaining radio resources (i.e., radio bearers) and for configuring the lower layers using RRC signaling between the eNB and the base station.

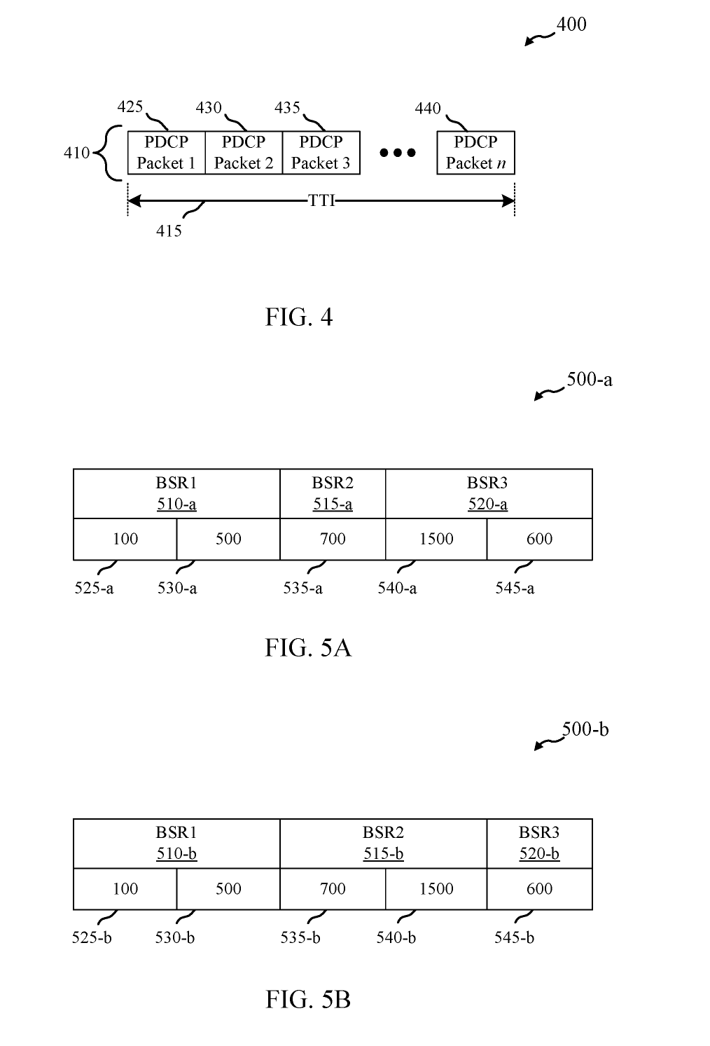

As discussed above, various examples provide wireless resource allocation and buffer status reporting based on packet size in a wireless communications system, such as wireless communications system 100 or 100 of FIG. 1 or FIG. 2. FIG. 4 illustrates an example of a wireless communications TTI that corresponds to a number of PDCP packets, including diagram 400 conceptually illustrating an example of wireless resources 410 that may be uplink or downlink and may be used for transmission of data, in accordance with aspects of the present disclosure. The wireless resources 410 of FIG. 4 may include wireless resources that span a TTI 415. In this example, wireless resources 410 may include sufficient resources for transmission of PDCP packets 425 through 440, corresponding to PDCP packet 1 425 through PDCP packet n 440, in which n is an integer number of PDCP packets. Wireless resources 410 may include, for example, portions of a radio frame that includes, for example, ten 1 ms subframes. In other examples, wireless resources 410 may include low latency or burst mode transmissions that may use a frame structure that allows for shorter duration symbols and variable TTI lengths. Such wireless resources 410 may be provided, for example, in an eCC on a SCell, although it will be understood that such transmission structures, as well as various of the techniques and principles described herein, may be implemented in other transmissions, such as within one or more subframes of a frame, in other PCell transmissions, in licensed or unlicensed spectrum, or the like.

In some examples, a base station (e.g., base station 105 of FIG. 1 or FIG. 2) may include a scheduler that may receive information about downlink data that is to be transmitted to a UE (e.g., UE 115 of FIG. 1 or FIG. 2). Such information may include, for example, a PDCP packet size and number of PDCP packets. The scheduler at the base station may be co-located with the MAC layer and have access to the number of PDCP packets and PDCP packet size. The scheduler may determine an allocation of downlink resources, such as wireless resources 410, that is adapted such that it accommodates an integer number of PDCP packets along with associated overhead from the MAC layer. Such resource allocation may include, for example, adapting a length of TTI 415 and associated resources within TTI 415 to accommodate the integer number of PDCP packets (and associated MAC overhead), which in the example of FIG. 4 is n PDCP packets 425 through 440. In some examples, the scheduler at the base station may adapt the TTI 415 based on one or more of available frequency resources, the PDCP packet size, or the number of PDCP packets, for example. In some examples, the PDCP data, number of PDCP packets, and PDCP packet size may be provided to the MAC layer for scheduling of the wireless resources 410 that are allocated, and transmission.

Determining an allocation of wireless resources 410 for downlink transmissions, as mentioned, may be performed by a base station using information that is available at the base station. In examples where wireless resources 410 are uplink resources, the scheduler at the base station may receive information related to the data waiting to be transmitted by the UE, and may use this information to determine an allocation of uplink resources to provide to the UE. Such information may be provided by the UE in a BSR, for example. In some examples, the BSR received at the base station may indicate a number of bits of data to be transmitted by the UE. In such cases, the scheduler at the base station may not have information about packet size and number of packets in the UE's PDCP. As discussed above, it may be desirable to allocate sufficient resources such that an integer number of PDCP packets and associated MAC layer overhead may be transmitted, such that RLC layer processing may be avoided. In such examples, a scheduler at a base station may allocate sufficient resources to schedule all data as reported in the BSR from the UE. In such examples, there is no loss due to the lack of the packet size information and segmentation functionality.

In other examples, a scheduler at a base station may determine that a BSR indicates a relatively large amount of data to be transmitted, such that a single allocation of wireless resources may not be sufficient to transmit all of the data. In such examples, the scheduler may allocate wireless resources that are relatively large, such that an integer number of packets may be transmitted in the allocated resources. Such allocations may, for example, assume a maximum PDCP packet size for scheduling, which may be based on one or a number of factors, such as the CC being used by the UE (e.g., a UE may use certain CCs for transmission of certain size packets, or a UE may utilize a contention based PUSCH for relatively small amounts of data).

In some cases, the allocation of wireless resources may result in some granted uplink resources that may not be utilized for data transmission, because the PDCP packet size along with associated MAC overhead does not result in an integer number of PDCP packets completely using the allocated resources. In such cases, rather than segment one or more PDCP packets, a UE may utilize padding to occupy the remaining resources. A UE may, in some examples, transmit a padding BSR in such remaining allocated resources, which may include additional information about remaining buffered packets (e.g., packet size and number of packets) that may be used by the scheduler to adapt subsequent uplink grants.

In other examples, a UE may transmit a BSR that includes multiple segments that may include information on a number of packets and packet size. Such a segmented BSR will be discussed in more detail below. A base station, upon receiving such a segmented BSR, may allocate uplink wireless resources to the UE based at least in part on the information in the segmented BSR, and thereby provide an allocation of resources having sufficient resources to transmit an integer number of packets. Such implementations may further enhance the utilization of available wireless resources. For example, similarly as discussed above, the scheduler may receive information related to a number of PDCP packets and a packet size, and may adapt a TTI of one or more available wireless resources to provide resources sufficient to transmit the integer number of PDCP packets.

As discussed above, various examples provide that a UE may generate and transmit a segmented BSR that may be used by a base station in determining a grant of uplink wireless resources. FIG. 5A and FIG. 5B illustrate examples of segmented BSR 500-a and segmented BSR 500-b, respectively, that may indicate information related to the buffered uplink data at a UE, in accordance with aspects of the present disclosure. Segmented BSRs 500 may be transmitted between UEs and base stations, such as UEs 115 and base stations 105 of FIG. 1 or FIG. 2. In the example of FIG. 5A, segmented BSR 500-a may include a first BSR part 510-a, a second BSR part 515-a, and a third BSR part 520-a. Each of the first BSR part 510-a, second BSR part 515-a, and third BSR part 520-a may correspond to, for example, an amount of data that a UE has in its transmission queue for different transmissions or different types of transmissions. For example, first BSR part 510 may correspond to a first data type that may correspond to a particular PDCP packet size.

A UE, in the example of FIG. 5A, may have a transmission queue with first uplink data 525-a that may include 100 bits of data in a first PDCP protocol data unit (PDU), and second uplink data 530-a that may include 500 bits of data. The UE may report the amount of data in each of first uplink data 525-a and second uplink data 530-a in the first BSR part 510-a, thus reporting, in this example, 600 bits of data in the first BSR part. Further, third uplink data 535-a in this example may have 700 bits of data, and may be reported by the UE in second BSR part 515-a. Finally, in this example, fourth uplink data 540-a and fifth uplink data 545-a may have 1500 and 600 bits of data, respectively, which may be reported in third BSR part 520-a. Thus, in this example, the UE may report a three segment BSR that reports 600 bits of data in first BSR part 510-a, 700 bits of data in second BSR part 515-a, and 2100 bits of data in third BSR part 520-a. Each of the first BSR part 510-a, second BSR part 515-a, and third BSR part 520-a may thus report an amount of data that corresponds to an integer number of packets. A base station may receive the segmented BSR 500-a, and may allocate uplink resources to the UE for transmission of the data, which may include uplink allocations for 600 bits of data, 1300 bits of data, or 3400 bits of data. The allocation of resources may include, similarly as discussed above, an indication of frequency resources for transmitting the data and a TTI to be used for transmitting the data. In such a manner, the UE may transmit data in its transmit buffer without segmentation. In certain examples, the segmented BSR 500-a may include a number of segments corresponding to a number of PDCP packets, with a value in each segment that indicates a number of bits corresponding to the PDCP packet size.

Furthermore, such BSR reporting may provide enhanced scheduling flexibility to a base station, as allocations may be made for certain, or all, BSR segments while maintaining the ability for the UE to transmit integer numbers of packets. In some examples, a segmented BSR may include information about packet sizes and a number of packets for each BSR segment. In other examples, different BSR segments may be configured that correspond to packet size bins, and a UE may report the number of packets to be transmitted that fall into each bin. The number of segments and part size bins for each BSR segment may be, for example, based on a predetermined BSR configuration, or based on a semi-statically configured BSR configuration. Further, a UE may, in some examples, also provide an indication of where in the UE's transmit queue the majority of packets of a given packet size bin fall, which may be used by the scheduler at the base station to allocate resources amongst multiple UEs.

In certain examples, the network may configure how such a segmented BSR is reported by the UE. For example, a number of parameters may be specified to be reported by a UE. Such a configuration may be signaled to the UE, for example, in RRC configuration information, such that the parameters to be reported may be semi-statically set by the base station. Such parameters may include, for example, a number of BSR segments, and a minimum and/or maximum value that may be reported for one or more BSR segments. Within the configured parameters, a UE may have, in some examples, flexibility in reporting BSR, or it may be specified that the UE is to balance the BSR across reported segments. For example, a base station may configure three BSR segments, with a minimum value that may be reported in each segment of 600 bits. In the example of FIG. 5A, the UE may thus report 600 bits of data in first BSR part 510-a, 700 bits of data in second BSR part 515-a, and 2100 bits of data in third BSR part 520-a. Alternatively, FIG. 5B illustrates segmented BSR 500-b in which fourth uplink data 540-b may be included in the second BSR part 515-b rather than in third BSR part 520-b. Thus, the UE could report 600 bits of data in first BSR part 510-b, 2200 bits of data in second BSR part 515-b, and 600 bits of data in third BSR part 520-b in the example of FIG. 5B. Such reporting of BSR may allow the UE to prioritize certain data, for example.

In still further examples, a UE may determine how many BSR segments are to be sent in a segmented BSR. In such examples, a UE may signal the number of BSR segments in the enhanced BSR MAC control element (CE). In other examples, a UE may indicate in a BSR that the UE has further data to send, such as through an “additional BSR” indication in the BSR MAC CE, for example.

Additionally or alternatively, the segmented parts and the sizes for the segmented parts of the BSR may indicate a first portion of the total data to be transmitted to the base station that is in a buffer of the UE, and a second portion of the total data in the UE buffer (e.g. some or all of the remaining data in the UE buffer) may also be indicated in the BSR. For example, a BSR may include segmented parts and sizes for the segmented parts to indicate a first portion of data in a UE buffer. The BSR may also contain, in addition to the segmented parts of the BSR, a non-segmented part of the BSR that indicates a size (e.g. indicated as a number of bytes) for a different portion of data in the UE buffer (e.g. a non-segmented part of the buffer). According to this example, the BSR may contain both a segmented part and a non-segmented part. In some examples, if the segment information for all of the data in a buffer is too long to report, the BSR may include an indication of segmented parts and size of the parts for a first portion of data in the buffer, and a remaining portion of data in the buffer may be reported as a size (e.g. a number of bytes).

In still further examples, a UE may prioritize certain logical channels when an uplink grant of wireless resources is received. For example, a UE may transmit a BSR, and subsequent to the BSR transmission, receive data for a higher priority logical channel. In such examples, the UE may transmit the higher priority data rather than the data that prompted the initial BSR. In some examples, a UE may, instead of following strict priority, take into account how much its buffer size will reduce after processing the grant, although strict priority for certain logical channels of very high priority may still be observed.

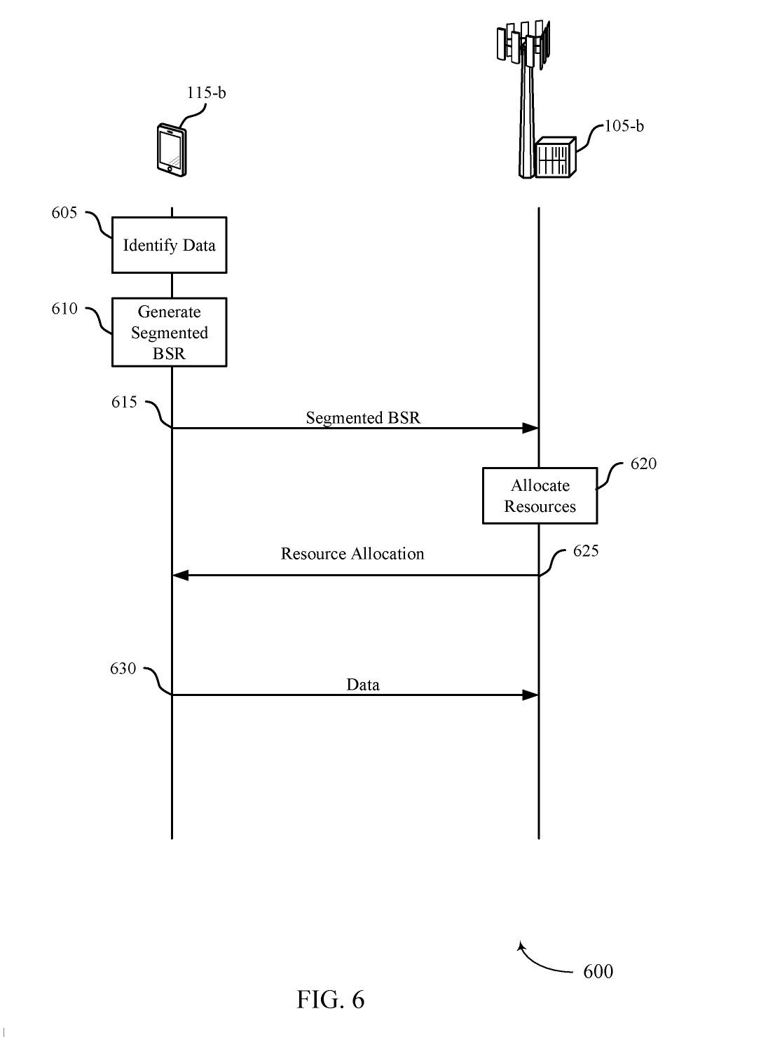

FIG. 6 illustrates an example of a process flow 600 for wireless resource allocation and buffer status reporting based on packet size in accordance with various aspects of the present disclosure. Process flow 600 may include a UE 115-b which may be an example of a UE 115 described above with reference to FIGS. 1-5. Process flow 600 may also include a base station 105-b, which may be an example of a base station 105 described above with reference to FIGS. 1-5. Although described in reference to a base station 105 and UEs 115, the steps of process flow 600 may be performed by any set of wireless devices performing wireless resource allocation and buffer status reporting based on packet size.

At step 605, UE 115-b may identify data that is to be transmitted in uplink wireless resources. Such an identification may be made according to established routines for such determinations, such as amounts of data to be transferred, determinations that data needs to be retransmitted, etc. At step 610, UE 115-b may generate a segmented BSR that may include two or more segments that indicate data that corresponds to an integer number of data packets, such as discussed above with respect to FIGS. 1-5. For example, UE 115-b may identify data that may be associated with multiple BSR segments, such that each BSR segment corresponds to an integer number of PDCP packets for the data. The UE 115-b may then transmit segmented BSR 615 to base station 105-b. The base station 105-b, at step 620, may allocate resources for uplink transmissions from the UE, in a manner similar as discussed above with respect to FIGS. 1-5. The base station 105-b may transmit the resource allocation 625 to the UE 115-b, and the UE 115-b may then transmit data 630 according to the uplink grant indicated in the resource allocation.

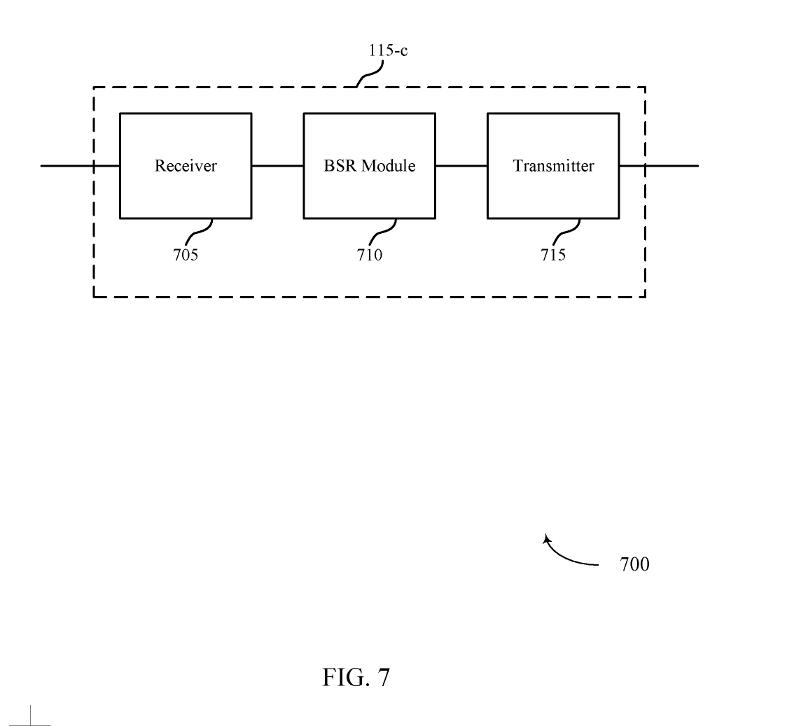

Turning next to FIG. 7, shown is a diagram 700 of a UE 115-c configured for buffer status reporting based on packet size, in accordance with various aspects of the present disclosure. UE 115-c may be an example of aspects of a UE 115, and may employ techniques, described with reference to FIGS. 1-6. UE 115-c may include a receiver 705, a BSR module 710, or a transmitter 715. UE 115-c may also include a processor and memory. Each of these components may be in communication with one another.

The receiver 705 may receive information such as packets, user data, or control information associated with various information channels (e.g., control channels, data channels, and resource allocation information related to variable TTI, etc.). Information may be passed on to the BSR module 710, and to other components of UE 115-c. In some examples, the receiver 705 may receive a resource allocation for uplink transmissions of an integer number of data packets in a variable uplink TTI. The receiver 705 may also receive signaling information, such as RRC configuration information, that may configure a format of BSR that the UE 115-c is to generate and transmit.

The BSR module 710 may identify data that is to be transmitted to a base station, may segment the identified data into a plurality of parts, and may generate a BSR that identifies the segmented parts and a size for each part. The size of each part may correspond to an integer number of data packets for different portions of the data that is to be transmitted. The resource allocation received at the receiver 705 may be based on the segmented BSR, and may include an allocation for an integer number of packets based on the BSR, according to various examples.

The transmitter 715 may transmit signals received from other components of UE 115-c. For example, transmitter 715 may transmit the BSR to a base station, and may transmit uplink data in accordance with uplink grants of allocated wireless resources. In some examples, the transmitter 715 may be co-located with the receiver 705 in a transceiver module. The transmitter 715 may include a single antenna, or it may include a plurality of antennas. In some examples, the transmitter 715 may transmit using variable length uplink TTIs.

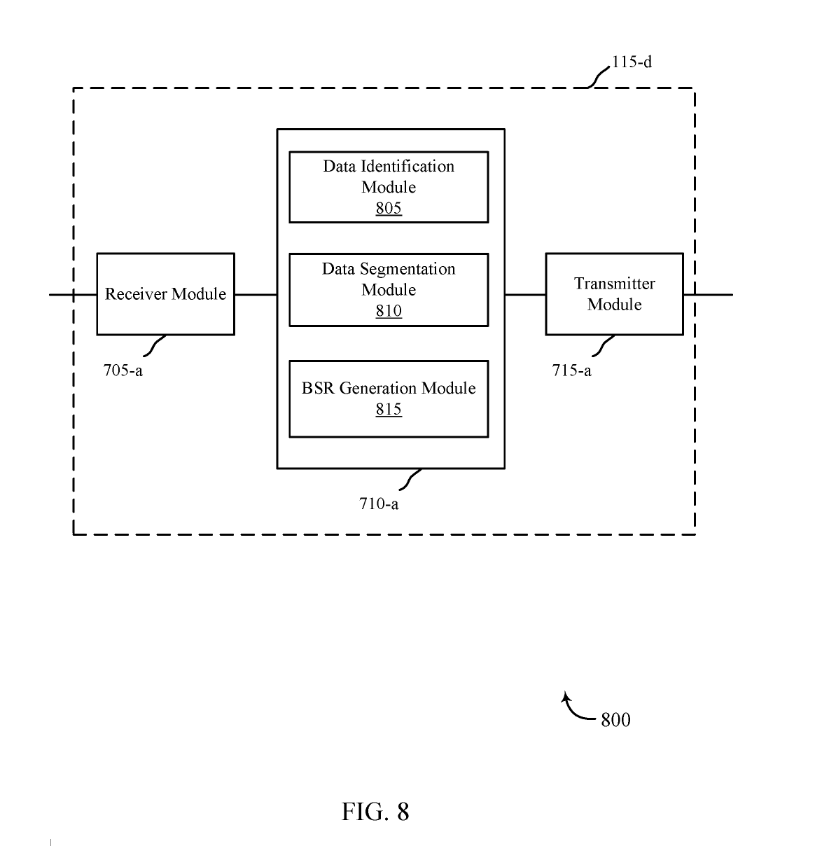

FIG. 8 shows a diagram 800 of a UE 115-d configured for buffer status reporting based on packet size, in accordance with various aspects of the present disclosure. UE 115-d may be an example of aspects of a UE 115, and may employ techniques, described with reference to FIGS. 1-7. UE 115-d may include a receiver 705-a, a BSR module 710-a, or a transmitter 715-a. UE 115-d may also include a processor and memory. Each of these components may be in communication with one another. The BSR module 710-a may also include a data identification module 805, a data segmentation module 810, and a BSR generation module 815.

The receiver 705-a may receive information which may be passed on to BSR module 710-a, and to other components of UE 115-d. The BSR module 710-a may perform the operations described above with reference to FIG. 7. The transmitter 715-a may transmit signals received from other components of UE 115-d.

The data identification module 805 may determine data that may be present, for example, in an uplink data buffer of the UE 115-d, as described above with reference to FIGS. 2-6. In some examples, the data identification module 805 may identify different types of data or different packet sizes associated with the uplink data, and may provide such information to the data segmentation module 810.

The data segmentation module 810, according to some examples, may receive the information from the data identification module 805 and determine different segments of the data. For example, data segmentation module 810 may determine a number of PDCP packets associated with the data, and may determine PDCP packet sizes for the data, as described above with reference to FIGS. 2-6. In some examples, the data segmentation module 810 may determine a number of PDCP packets associated with one or more segments of data, along with a size of the PDCP packets.

The BSR generation module 815 according to some examples, may generate a BSR having one or more segments, as described above with reference to FIGS. 2-6. In some examples, the BSR generation module 815 may segment the BSR corresponding to a number of PDCP packets, and generate an indication of a number of bits for each segment corresponding to the PDCP packet size.

In other examples, the data identification module 805 may identify different types of data or different packet sizes associated with the uplink data in an uplink data buffer of a UE 115-d, and also identify and generate an indication of a size (e.g. a number of bytes) associated with a second portion of data in the buffer of UE 115-d, and may provide such information to the data segmentation module 810. BSR generation module 815 may generate the BSR to include both the indication of the number of bytes associated with the second portion of data, in addition to generating the BSR to have the indication of the number of bits for each segment corresponding to the PDCP packet size for the one or more PDCP packets, which are associated with a first portion of data in the buffer. Thus, the BSR generation module 815 may generate a BSR having both one or more segmented parts (and sizes for the segmented parts) for data in a buffer, and a non-segmented part that indicates a size (e.g. a number of bytes) for other data in the buffer, which may be the remaining data in the buffer.

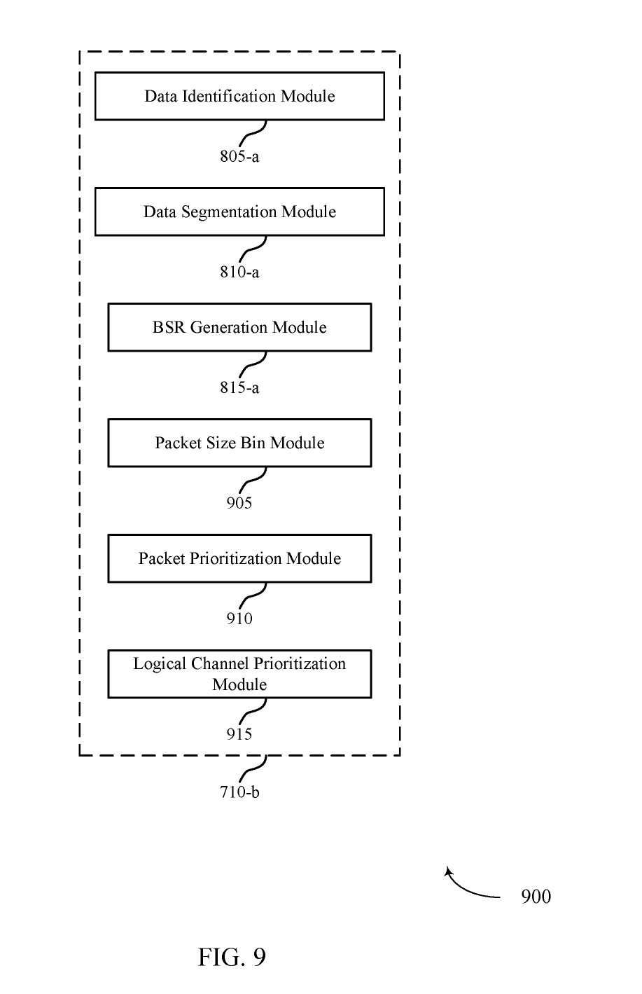

FIG. 9 shows a diagram 900 of a BSR module 710-b configured for buffer status reporting based on packet size in accordance with various aspects of the present disclosure. The BSR module 710-b may be an example of aspects of a BSR module 710 described with reference to FIGS. 7-8. The BSR module 710-b may include a data identification module 805-a, a data segmentation module 810-a, and a BSR generation module 815-a. Each of these modules may perform the functions of data identification module 805, data segmentation module 810, and BSR generation module 815 described above with reference to FIG. 8. The BSR module 710-b may also include a packet size bin module 905, a packet prioritization module 910, and a logical channel prioritization module 915.

The packet size bin module 905 may determine a number of packet size bins, and a determine a number of packets to be transmitted that fall into each bin, as described above with reference to FIGS. 2-6. The packet prioritization module 910 may determine a relative priority for different packets to be transmitted, and may use such priority to determine packets that are to be included in certain segments of the BSR, as described above with reference to FIGS. 2-6. The logical channel prioritization module 915 may determine logical channel priority for data to be transmitted and may use such priority to determine packets that are to be included in certain segments of the BSR, or to determine that uplink resources allocated based on a previous BSR are to be used for newly received data in a channel having higher channel priority than the data that was used to generate the previous BSR, as described above with reference to FIGS. 2-6.

The components of UE 115-c, UE 115-d, or BSR module 710-b may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

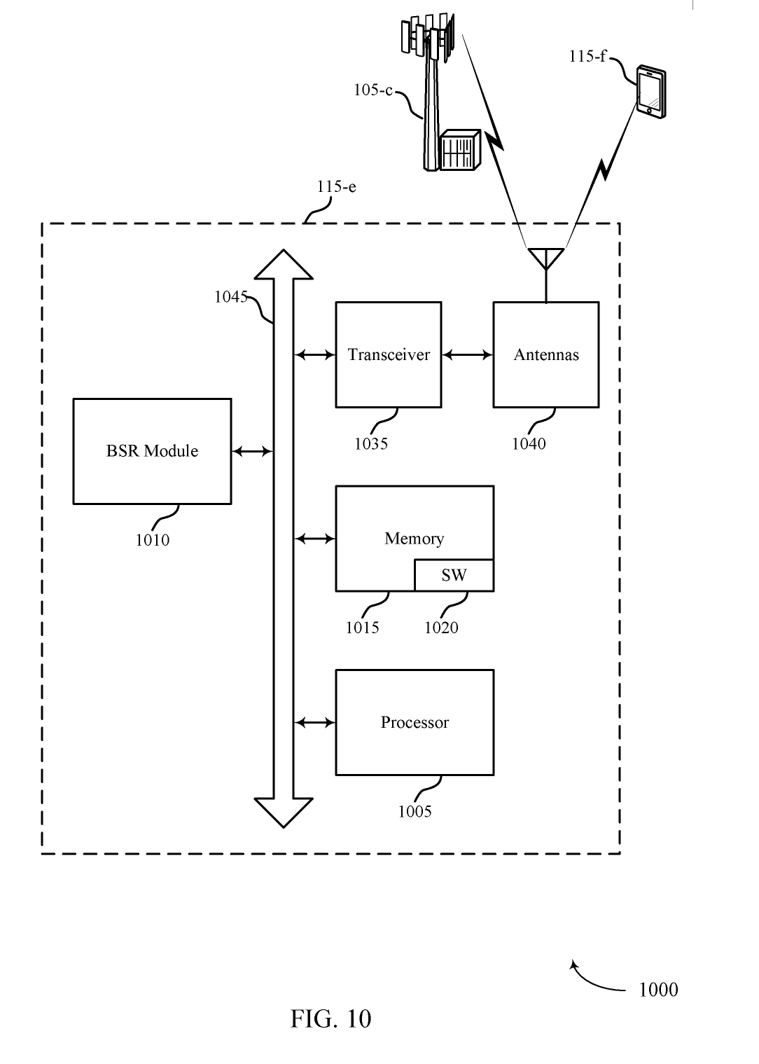

FIG. 10 shows a diagram of a system 1000 including a UE 115 configured for buffer status reporting based on packet size in accordance with various aspects of the present disclosure. System 1000 may include UE 115-e, which may be an example of a UE 115 described above with reference to FIGS. 1-9. UE 115-e may include a BSR module 1010, which may be an example of a BSR module 710 described with reference to FIGS. 7-9. UE 115-e may also include components for bi-directional voice and data communications including components for transmitting communications and components for receiving communications. For example, UE 115-e may communicate bi-directionally with UE 115-f or base station 105-c.

UE 115-e may also include a processor module 1005, and memory 1015 (including software (SW) 1020), a transceiver module 1035, and one or more antenna(s) 1040, each of which may communicate, directly or indirectly, with each other (e.g., via buses 1045). The transceiver module 1035 may communicate bi-directionally, via the antenna(s) 1040 or wired or wireless links, with one or more networks, as described above. For example, the transceiver module 1035 may communicate bi-directionally with a base station 105 or another UE 115. The transceiver module 1035 may include a modem to modulate the packets and provide the modulated packets to the antenna(s) 1040 for transmission, and to demodulate packets received from the antenna(s) 1040. While UE 115-e may include a single antenna 1040, UE 115-e may also have multiple antennas 1040 capable of concurrently transmitting or receiving multiple wireless transmissions.

The memory 1015 may include random access memory (RAM) and read only memory (ROM). The memory 1015 may store computer-readable, computer-executable software/firmware code 1020 including instructions that, when executed, cause the processor module 1005 to perform various functions described herein (e.g., BSR reporting, variable TTI, and the like). Alternatively, the software/firmware code 1020 may not be directly executable by the processor module 1005 but cause a computer (e.g., when compiled and executed) to perform functions described herein. The processor module 1005 may include an intelligent hardware device, (e.g., a central processing unit (CPU), a microcontroller, an ASIC, etc.).

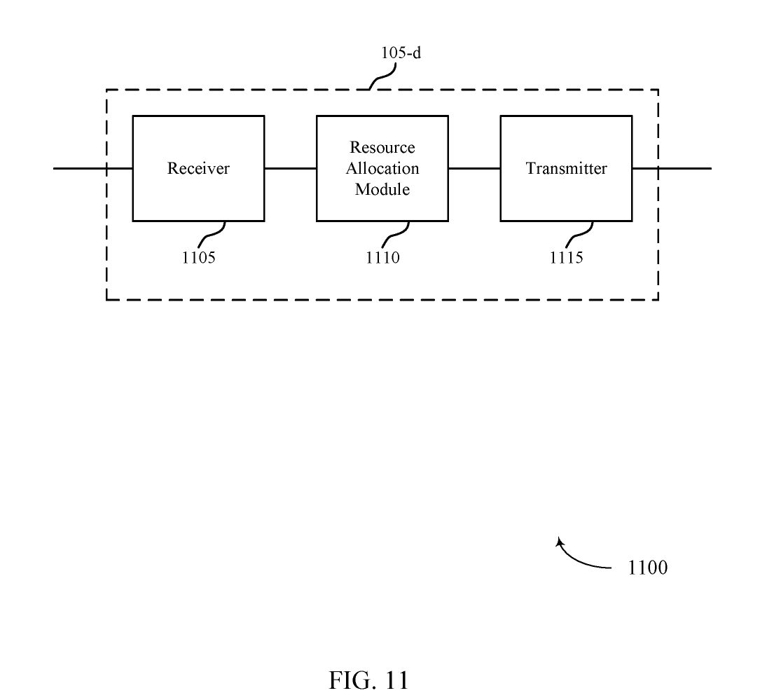

FIG. 11 shows a diagram 1100 of a base station 105-d configured for wireless resource allocation based on packet size in accordance with various aspects of the present disclosure. Base station 105-d may be an example of aspects of a base station 105, and may employ techniques, described with reference to FIGS. 1-6. Base station 105-d may include a receiver 1105, a resource allocation module 1110, or a transmitter 1115. Base station 105-d may also include a processor and memory. Each of these components may be in communication with one another.

The receiver 1105 may receive information such as packets, user data, or control information associated with various information channels (e.g., control channels, data channels, BSR information, etc.). Information may be passed on to the resource allocation module 1110, and to other components of base station 105-d.

The resource allocation module 1110 may determine downlink resource allocations or uplink resource allocations to as to provide resources to transmit an integer number of data packets, as discussed above with respect to FIGS. 2-6.

The transmitter 1115 may transmit signals received from other components of base station 105-d. In some examples, the transmitter 1115 may be co-located with the receiver 1105 in a transceiver module. The transmitter 1115 may include a single antenna, or it may include a plurality of antennas. In some examples, the transmitter 1115 may transmit an uplink grant to a UE of allocated resources that may be used to transmit an integer number of data packets.

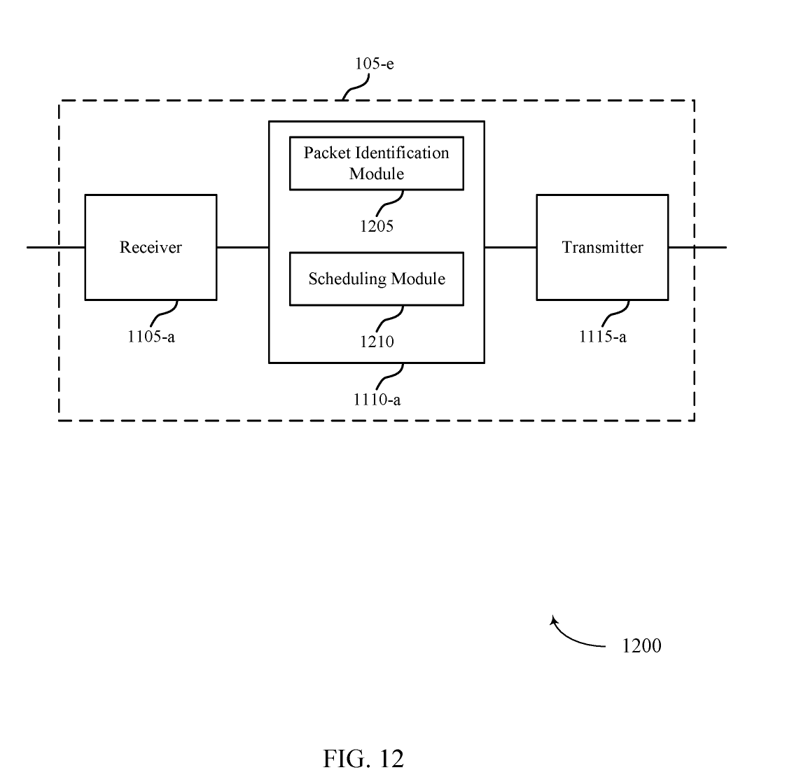

FIG. 12 shows a diagram 1200 of a base station 105-e configured for wireless resource allocation based on packet size in accordance with various aspects of the present disclosure. Base station 105-e may be an example of aspects of a base station 105, and may employ techniques, described with reference to FIGS. 1-6 and 11. Base station 105-e may include a receiver 1105-a, a resource allocation module 1110-a, or a transmitter 1115-a. Base station 105-e may also include a processor and memory. Each of these components may be in communication with one another. The resource allocation module 1110-a may also include a packet identification module 1205, and a scheduling module 1210.

The receiver 1105-a may receive information which may be passed on to resource allocation module 1110-a, and to other components of base station 105-b. The resource allocation module 1110-a may perform the operations described above with reference to FIG. 11. The transmitter 1115-a may transmit signals received from other components of base station 105-b.

The packet identification module 1205 may identify one or more downlink packets to be transmitted to one or more UEs, such as one or more PDCP packets, as discussed above with respect to FIGS. 2-6. The packet identification module 1205 also may identify a packet size associated with the one or more downlink packets, as discussed above with respect to FIGS. 2-6. In some examples, the packet identification module 1205 may identify one or more segmented parts (e.g. one or more PDCP packets) and a packet size for the segmented parts (e.g. a packet size for each of the one or more PDCP packets) from a BSR received from a UE, as discussed above with respect to FIGS. 2-6.

The scheduling module 1210 may schedule resource allocations associated with downlink or uplink transmissions so as to provide resources for transmission of an integer number of packets, as described above with reference to FIGS. 2-6. In some examples, the scheduling module 1210 may schedule resource allocations to a UE based at least in part on the number of segmented parts and the sizes for the segmented part identified in a BSR from the UE, as described above with reference to FIGS. 2-6.

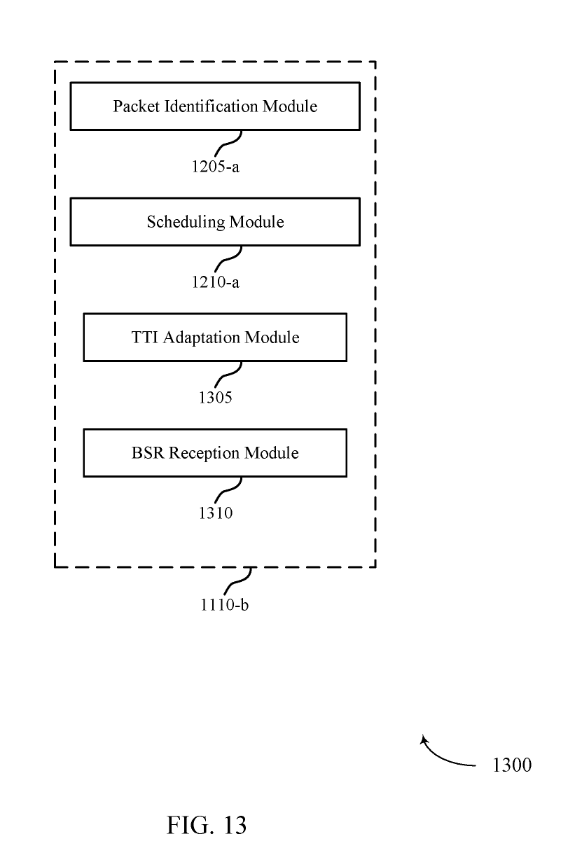

FIG. 13 shows a diagram 1300 of a resource allocation module 1110-b for wireless resource allocation based on packet size in accordance with various aspects of the present disclosure. The resource allocation module 1110-b may be an example of aspects of a resource allocation module 1110, and may employ techniques, described with reference to FIGS. 11-12. The resource allocation module 1110-b may include a packet identification module 1205-a and a scheduling module 1210-a. These modules may perform the functions of packet identification module 1205 and scheduling module 1210 described above with reference to FIG. 12. The resource allocation module 1110-b may also include a TTI adaptation module 1305, and a BSR reception module 1310.

The TTI adaptation module 1305 may configure a TTI for data transmission to provide resources for transmission of an integer number of packets, as described above with reference to FIGS. 2-6. The TTI adaptation module 1305 may adaptively set TTIs for uplink or downlink transmissions based on one or more packet sizes or amount of resources necessary to transmit integer numbers of packets, such as discussed above with reference to FIGS. 2-6. The BSR reception module 1310 may receive a segmented BSR from one or more UEs, and provide data segment information to other modules such that resources may be allocated to provide for transmission of integer numbers of packets, as described above with reference to FIGS. 2-6.

The components of base station 105-d, base station 105-e, or resource allocation module 1110-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

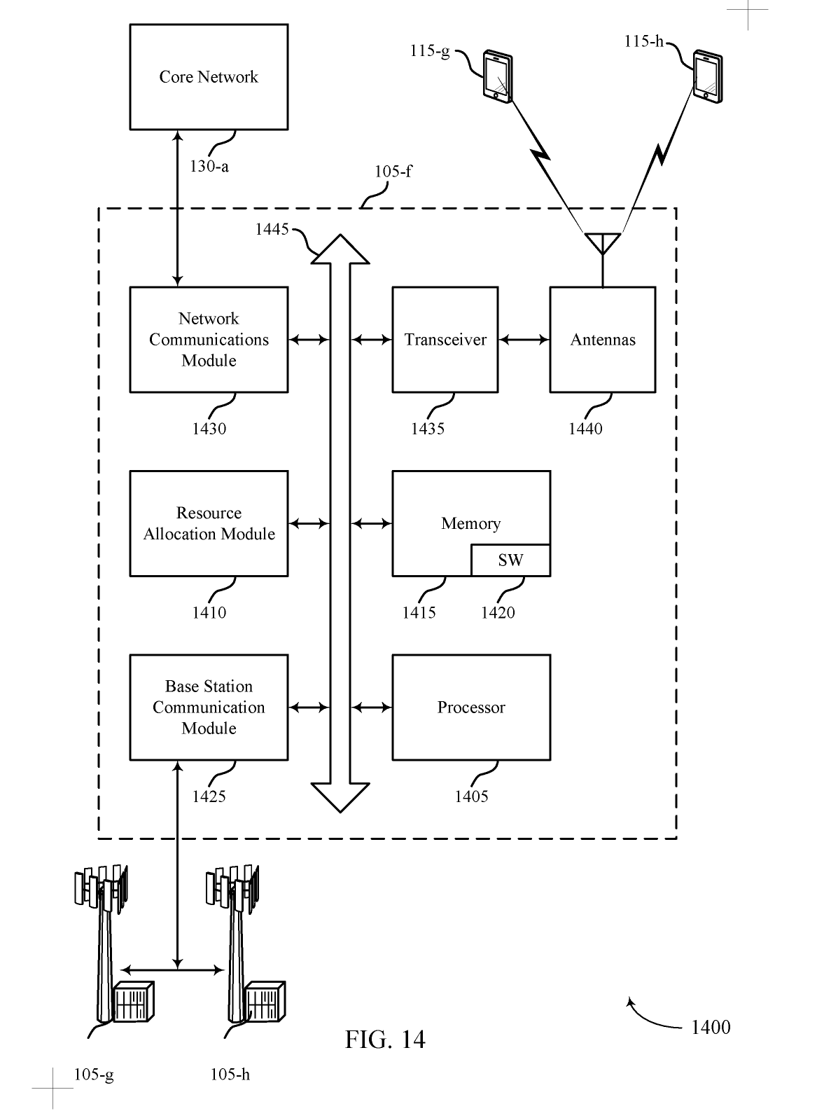

FIG. 14 shows a diagram of a system 1400 including a base station 105 configured for wireless resource allocation based on packet size in accordance with various aspects of the present disclosure. System 1400 may include base station 105-f, which may be an example of a base station 105, and may employ techniques, described above with reference to FIGS. 1-13. Base station 105-f may include a resource allocation module 1410, which may be an example of a resource allocation module 1110 described with reference to FIGS. 11-13. Base station 105-f may also include components for bi-directional voice and data communications including components for transmitting communications and components for receiving communications. For example, base station 105-f may communicate bi-directionally with base station 105-g or base station 105-h.

In some cases, base station 105-f may have one or more wired backhaul links. Base station 105-f may have a wired backhaul link (e.g., S1 interface, etc.) to the core network 130-a. Base station 105-f may also communicate with other base stations 105, such as base station 105-g and base station 105-h via inter-base station backhaul links (e.g., an X2 interface). Each of the base stations 105 may communicate with UEs 115 using the same or different wireless communications technologies. In some cases, base station 105-f may communicate with other base stations such as 105-g or 105-g utilizing base station communication module 1425. In some examples, base station communication module 1425 may provide an X2 interface within an LTE/LTE-A wireless communication network technology to provide communication between some of the base stations 105. Additionally or alternatively, base station 105-f may communicate with other base stations through core network 130-a. In some cases, base station 105-f may communicate with the core network 130-a through network communications module 1430.

The base station 105-f may include a processor module 1405, memory 1415 (including software (SW) 1420), transceiver modules 1435, and antenna(s) 1440, which each may be in communication, directly or indirectly, with one another (e.g., over bus system 1445). The transceiver modules 1435 may be configured to communicate bi-directionally, via the antenna(s) 1440, with the UEs 115, which may be multi-mode devices. The transceiver module 1435 (or other components of the base station 105-f) may also be configured to communicate bi-directionally, via the antennas 1440, with one or more other base stations (not shown). The transceiver module 1435 may include a modem configured to modulate the packets and provide the modulated packets to the antennas 1440 for transmission, and to demodulate packets received from the antennas 1440. The base station 105-f may include multiple transceiver modules 1435, each with one or more associated antennas 1440. The transceiver module 1435 may be an example of a combined receiver 1105 and transmitter 1115 of FIGS. 11-12.

The memory 1415 may include RAM and ROM. The memory 1415 may also store computer-readable, computer-executable software/firmware code 1420 containing instructions that are configured to, when executed, cause the resource allocation module 1410 to perform various functions described herein (e.g., receive or transmit feedback for variable TTI, selecting coverage enhancement techniques, call processing, database management, message routing, etc.). Alternatively, the software/firmware code 1420 may not be directly executable by the processor module 1405 but be configured to cause the computer, e.g., when compiled and executed, to perform functions described herein. The processor module 1405 may include an intelligent hardware device, e.g., a CPU, a microcontroller, an ASIC, etc. The processor module 1405 may include various special purpose processors such as encoders, queue processing modules, base band processors, radio head controllers, digital signal processors (DSPs), and the like.

The base station communication module 1425 may manage communications with other base stations 105. The base station communication module 1425 may include a controller or scheduler for controlling communications with UEs 115 in cooperation with other base stations 105. For example, the base station communication module 1425 may coordinate scheduling for transmissions to UEs 115 for various interference mitigation techniques such as beamforming or joint transmission.

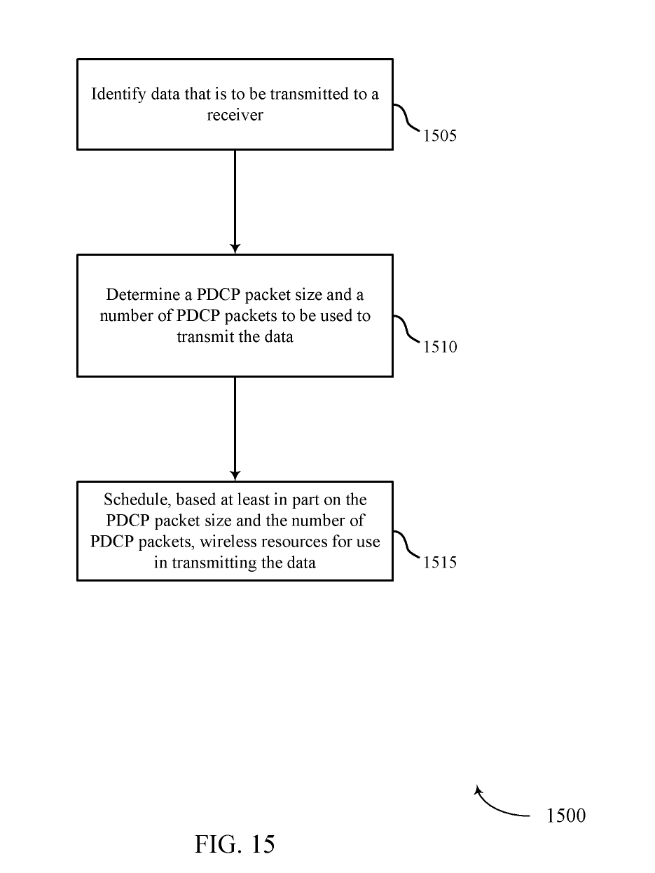

FIG. 15 shows a flowchart illustrating a method 1500 for wireless resource allocation based on packet size in accordance with various aspects of the present disclosure. The operations of method 1500 may be implemented by a base station 105 or its components as described with reference to FIGS. 1-6 and 11-14. For example, the operations of method 1500 may be performed by the resource allocation module 1110 as described with reference to FIGS. 11-14. In some examples, a base station 105 may execute a set of codes to control the functional elements of the base station 105 to perform the functions described below. Additionally or alternatively, the base station 105 may perform aspects the functions described below using special-purpose hardware.

At block 1505, the base station 105 may identify data that is to be transmitted to a receiver, as described above with reference to FIGS. 2-6. In certain examples, the operations of block 1505 may be performed by the packet identification module 1205, as described above with reference to FIG. 12.

At block 1510, the base station 105 may determine a PDCP packet size and a number of PDCP packets to be used to transmit the data, as described above with reference to FIGS. 2-6. In certain examples, the operations of block 1510 may be performed by the packet identification module 1205, as described above with reference to FIG. 12.

At block 1515, the base station 105 may schedule, based at least in part on the PDCP packet size and the number of PDCP packets, wireless resources for use in transmitting the data, as described above with reference to FIGS. 2-6. In certain examples, the operations of block 1515 may be performed by the scheduling module 1210, as described above with reference to FIG. 12.

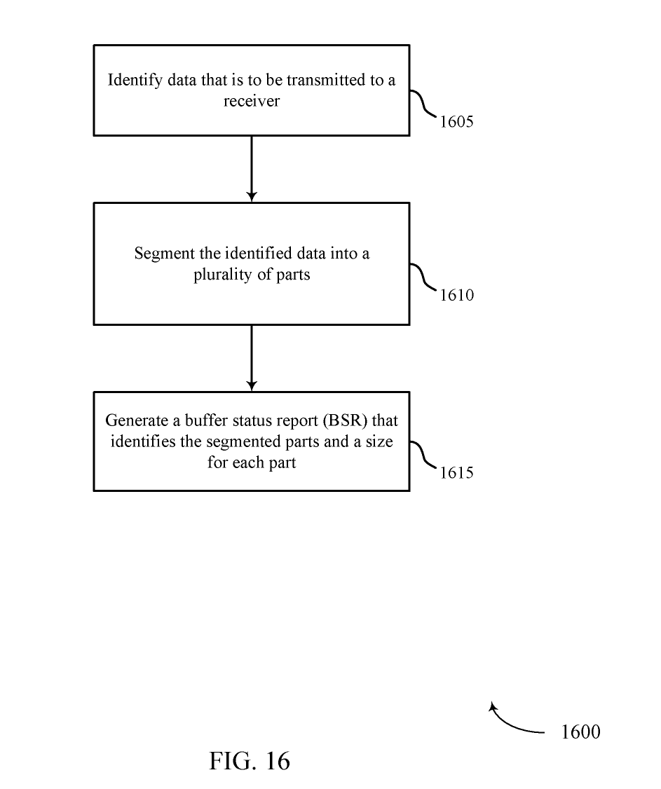

FIG. 16 shows a flowchart illustrating a method 1600 for buffer status reporting based on packet size in accordance with various aspects of the present disclosure. The operations of method 1600 may be implemented by a UE 115 or its components as described with reference to FIGS. 1-10. For example, the operations of method 1600 may be performed by the BSR module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware.

At block 1605, the UE 115 may identify data that is to be transmitted to a receiver, as described above with reference to FIGS. 2-6. In certain examples, the operations of block 1605 may be performed by the data identification module, as described above with reference to FIG. 8.

At block 1610, the UE 115 may segment the identified data into a plurality of parts, as described above with reference to FIGS. 2-6. In certain examples, the operations of block 1610 may be performed by the data segmentation module 810, as described above with reference to FIG. 8.

At block 1615, the UE 115 may generate a BSR that identifies the segmented parts and a size for each part, as described above with reference to FIGS. 2-6. In certain examples, the operations of block 1615 may be performed by the BSR generation module 815, as described above with reference to FIG. 8.

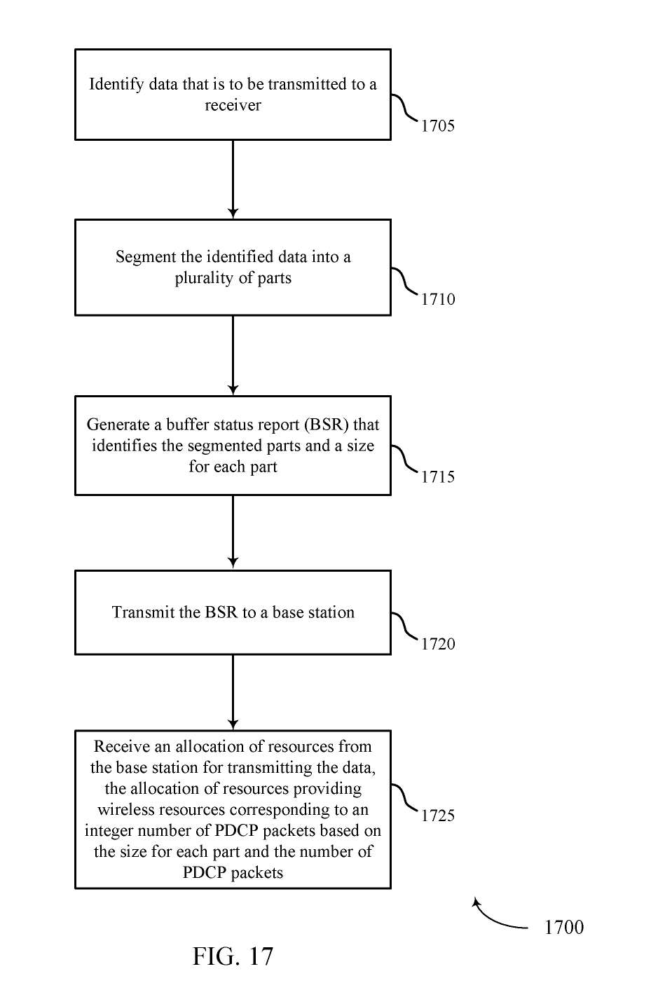

FIG. 17 shows a flowchart illustrating a method 1700 for buffer status reporting based on packet size in accordance with various aspects of the present disclosure. The operations of method 1700 may be implemented by a UE 115 or its components as described with reference to FIGS. 1-10. For example, the operations of method 1700 may be performed by the BSR module 710 as described with reference to FIGS. 7-10. In some examples, a UE 115 may execute a set of codes to control the functional elements of the UE 115 to perform the functions described below. Additionally or alternatively, the UE 115 may perform aspects the functions described below using special-purpose hardware.

At block 1705, the UE 115 may identify data that is to be transmitted to a receiver, as described above with reference to FIGS. 2-6. In certain examples, the operations of block 1705 may be performed by the data identification module, as described above with reference to FIG. 8.

At block 1710, the UE 115 may segment the identified data into a plurality of parts, as described above with reference to FIGS. 2-6. In certain examples, the operations of block 1710 may be performed by the data segmentation module 810, as described above with reference to FIG. 8.

At block 1715, the UE 115 may generate a BSR that identifies the segmented parts and a size for each part, as described above with reference to FIGS. 2-6. In certain examples, the operations of block 1715 may be performed by the BSR generation module 815, as described above with reference to FIG. 8.

At block 1720, the UE 115 may transmit the BSR to a base station, as described above with reference to FIGS. 2-6. In certain examples, the operations of block 1720 may be performed by the transmitter 715 of FIG. 7 in conjunction with the BSR generation module 815, as described above with reference to FIG. 8.

At block 1725, the UE 115 may receive an allocation of resources from the base station for transmitting the data, the allocation of resources providing wireless resources corresponding to an integer number of PDCP packets based on the size for each part and the number of PDCP packets, as described above with reference to FIGS. 2-6. In certain examples, the operations of block 1725 may be performed by the receiver 705, as described above with reference to FIG. 7.

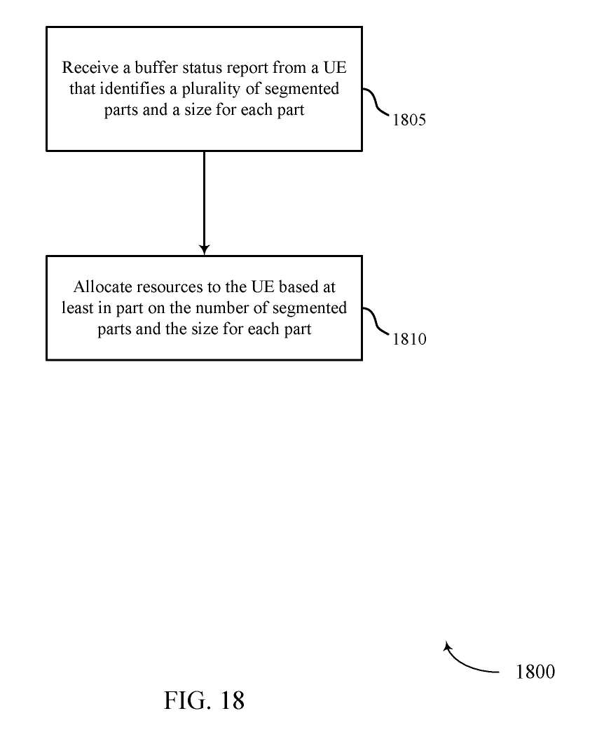

FIG. 18 shows a flowchart illustrating a method 1800 for wireless resource allocation based on packet size in accordance with various aspects of the present disclosure. The operations of method 1800 may be implemented by a base station 105 or its components as described with reference to FIGS. 1-6 and 11-14. For example, the operations of method 1800 may be performed by the resource allocation module 1110 as described with reference to FIGS. 11-14. In some examples, a base station 105 may execute a set of codes to control the functional elements of the base station 105 to perform the functions described below. Additionally or alternatively, the base station 105 may perform aspects the functions described below using special-purpose hardware.

At block 1805, the base station 105 may receive a buffer status report from a UE that identifies a plurality of segmented parts and a size for each part, as described above with reference to FIGS. 2-6. In certain examples, the operations of block 1805 may be performed by the BSR reception module 1310, as described above with reference to FIG. 13, in conjunction with the receiver 1105, as described above with reference to FIG. 11.

At block 1810, the base station 105 may allocate resources to the UE based at least in part on the number of segmented parts and the size for each part, as described above with reference to FIGS. 2-6. In certain examples, the operations of block 1810 may be performed by the scheduling module 1210, as described above with reference to FIG. 12.

Thus, methods 1500, 1600, 1700, and 1800 may provide for BSR reporting and resource allocation based on packet size. In some examples, aspects from two or more of the methods 1500, 1600, 1700 or 1800 described with reference to FIG. 15, 16, 17, or 18 may be combined. It should be noted that the methods 1500, 1600, 1700, and 1800 are just example implementations, and that the operations of the methods 1500, 1600, 1700, or 1800 may be rearranged or otherwise modified such that other implementations are possible.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in diagram or block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication at a wireless device, comprising:
identifying data that is to be transmitted to a receiver;
segmenting the identified data into a plurality of parts; and
generating a buffer status report (BSR) that identifies the segmented parts and sizes for the segmented parts.

2. The method of claim 1, further comprising:
transmitting the BSR to a base station; and
receiving an allocation of resources from the base station for transmitting the data, the allocation of resources providing wireless resources corresponding to an integer number of packet data convergence protocol (PDCP) packets based at least in part on the sizes for the segmented parts and the integer number of PDCP packets.

3. The method of claim 2, wherein the allocation of resources provides wireless resources for transmitting a subset of the integer number of PDCP packets.

4. The method of claim 2, wherein the allocation of resources comprises an indication of frequency resources for transmitting the data and a transmission time interval (TTI) to be used for transmitting the data.

5. The method of claim 1, wherein the BSR comprises a plurality of segments corresponding to a number of packet data convergence protocol (PDCP) packets and an indication of a number of bits for a segment of the plurality of segments corresponding to a PDCP packet size.

6. The method of claim 1, wherein the BSR comprises a plurality of segments, a segment of the plurality of segments corresponding to a part size bin and the segment indicating a number of parts within the part size bin.

7. The method of claim 6, wherein the segment and the part size bin for the segment is determined based at least in part on one or more of a predetermined BSR configuration, or a semi-statically configured BSR configuration.

8. The method of claim 6, wherein the BSR further comprises an indication of a location in a transmission queue where a majority of parts of the part size bin fall.

9. The method of claim 1, wherein the BSR comprises a plurality of segments, a segment of the plurality of segments having one or more of a minimum or maximum value to indicate a part size associated with the segment.

10. The method of claim 9, wherein the plurality of parts corresponds to an integer number of PDCP packets, and a number of PDCP packets reported in the segment is selected to prioritize one or more PDCP packets.

11. The method of claim 9, wherein the plurality of parts corresponds to an integer number of PDCP packets, and a number of PDCP packets reported in the segment is selected to balance PDCP packets reported in the segment.

12. The method of claim 1, wherein the BSR comprises one or more BSR segments, a number of BSR segments determined based at least in part on a number of the plurality of parts.

13. The method of claim 12, wherein the BSR further comprises an indication of the number of BSR segments.

14. The method of claim 1, wherein the identified data is associated with a first portion of data in a buffer, and wherein the BSR further identifies a size for a non-segmented portion of data in the buffer.

15. The method of claim 1, wherein the BSR further comprises an indication that additional data is to be transmitted.

16. The method of claim 15, further comprising:
determining that the additional data is to be transmitted, the additional data having higher priority than a first logical channel prioritization, wherein the BSR is based at least in part on data having the first logical channel prioritization; and
determining to transmit the additional data ahead of the data having the first logical channel prioritization based at least in part on an allocation of wireless resources received responsive to the BSR.

17. A method for wireless communication at a wireless device, comprising:
receiving a buffer status report from a user equipment (UE) that identifies a plurality of segmented parts and sizes for the segmented parts; and
allocating wireless resources to the UE based at least in part on a number of the segmented parts and the sizes for the segmented parts.

18. The method of claim 17, wherein the plurality of segmented parts corresponds to an integer number of packet data convergence protocol (PDCP) packets.

19. The method of claim 18, wherein the allocating further comprises:
adapting a transmission time interval (TTI) of one or more available wireless resources to provide the integer number of PDCP packets.

20. The method of claim 17, wherein the allocating further comprises:
identifying data that is to be transmitted to the UE;
determining a packet data convergence protocol (PDCP) packet size and a number of PDCP packets to be used to transmit the data; and
scheduling, based at least in part on the PDCP packet size and the number of PDCP packets, wireless resources for use in transmitting the data.

21. The method of claim 20, wherein the identifying and the determining are performed at a PDCP layer, and wherein the method further comprises:
providing the data, the PDCP packet size, and the number of PDCP packets to a medium access control (MAC) layer for transmission to the UE.

22. The method of claim 21, wherein the scheduling is performed by a scheduler that is associated with the MAC layer.

23. An apparatus for communication at a wireless device, comprising:
a processor;
memory in electronic communication with the processor; and
instructions stored in the memory, the instructions being executable by the processor to:
identify data that is to be transmitted to a receiver;
segment the identified data into a plurality of parts; and
generate a buffer status report (BSR) that identifies the segmented parts and sizes for the segmented parts.

24. The apparatus of claim 23, wherein the instructions are further executable by the processor to:
transmit the BSR to a base station; and
receive an allocation of resources from the base station for transmitting the data, the allocation of resources providing wireless resources corresponding to an integer number of packet data convergence protocol (PDCP) packets based at least in part on the sizes for the segmented parts and the integer number of PDCP packets.

25. The apparatus of claim 23, wherein the BSR comprises a plurality of segments corresponding to a number of packet data convergence protocol (PDCP) packets and an indication of a number of bits for a segment of the plurality of segments corresponding to a PDCP packet size.

26. The apparatus of claim 23, wherein the BSR comprises a plurality of segments, a segment of the plurality of segments corresponding to a part size bin and the segment indicating a number of parts within the part size bin.

27. The apparatus of claim 23, wherein the BSR comprises a plurality of segments, a segment of the plurality of segments having one or more of a minimum or maximum value to indicate a part size associated with the segment.

28. An apparatus for wireless communication at a wireless device, comprising:
a processor;
memory in electronic communication with the processor; and
instructions stored in the memory and executable by the processor to cause the apparatus to:
receive a buffer status report from a user equipment (UE) that identifies a plurality of segmented parts and sizes for the segmented parts; and
allocate wireless resources to the UE based at least in part on a number of the segmented parts and the sizes for the segmented parts.

29. The apparatus of claim 28, wherein the plurality of segmented parts corresponds to an integer number of packet data convergence protocol (PDCP) packets.

30. The apparatus of claim 28, wherein the instructions are further executable by the processor to cause the apparatus to:
identify data that is to be transmitted to the UE;
determine the packet data convergence protocol (PDCP) packet size and a number of PDCP packets to be used to transmit the data; and
schedule, based at least in part on the PDCP packet size and the number of PDCP packets, wireless resources for use in transmitting data, wherein the scheduling comprises determining the one or more frequency resources for transmitting the data.
